(19) United States
(12) Patent Application Publication
(10) Pub. No.: US 2017/0295019 A1
(43) Pub. Date: Oct. 12, 2017

(54) COMMUNICATION DEVICE AND PACKET TRANSMISSION/RECEPTION PROGRAM

(71) Applicant: FUJITSU LIMITED, Kawasaki-shi (JP)

(72) Inventors: Isamu Fukuda, Yokohama (JP); Tetsuta SAKABE, Yokohama (JP); Katsuhiko Negoto, Yokohama (JP); KIYOHISA HOSHINO, Yokohama (JP); Akihiro KAMEDA, Kawasaki (JP); Kazuhiro Yasuno, Yokohama (JP)

(73) Assignee: FUJITSU LIMITED, Kawasaki-shi (JP)

(21) Appl. No.: 15/471,167

(22) Filed: Mar. 28, 2017

(30) Foreign Application Priority Data
Apr. 11, 2016 (JP) 2016-078821

(51) Int. Cl. H04L 9/32; H04L 29/06

(52) U.S. Cl. CPC H04L 9/3226; H04L 69/22; H04L 63/0428; H04L 43/16

(57) ABSTRACT

A communication device includes, a plurality of authentication generation processing units, which are respectively associated with different sequence number groups each including successive sequence numbers and which execute, in parallel, authentication generation processes for generating authentication information included in the packets based on sequence numbers allocated to the packets, a transmitting unit which transmits packets including the allocated sequence numbers to another communication device in an order in which authentication generation processes by the plurality of authentication generation processing units are completed, a receiving unit which receives a packet from the other communication device, and an authentication processing unit which executes a first authentication process in which the reception packet is authenticated based on a relationship between a sequence number of the reception packet and a sequence number of a preceding reception packet.

### CROSS-REFERENCE TO RELATED APPLICATION

This application is based upon and claims the benefit of priority of the prior Japanese Patent Application No. 2016-078821, filed on Apr. 11, 2016, the entire contents of which are incorporated herein by reference.

### FIELD

The present invention relates to a communication device and a packet transmission/reception program.

### BACKGROUND

In recent years, communication protocols having data tampering prevention and secrecy functions such as security architecture for Internet Protocol (IPsec) are attracting attention.

A communication device which communicates using IPsec performs authentication of a received packet to check whether or not the packet is not an unauthorized packet. A transmitting-side communication device transmits packets in an order of sequence numbers. On the other hand, a communication device having received the packets performs authentication based on sequence numbers which the transmitting-side communication device had attached to the packets and which indicate a transmission order of the packets. In other words, in authentication based on sequence numbers, for example, when the receiving-side communication device receives a packet with a sequence number that is older than a latest received sequence number by a reference value or more, the receiving-side communication device determines that the received packet is an unauthorized packet and discards the received packet.

In addition, the transmitting-side communication device generates authentication information based on a sequence number and encrypted data, and includes the authentication information in a packet and then transmits the packet. The receiving-side communication device generates authentication information based on the sequence number and the encrypted data in the received packet, and determines whether or not the generated authentication information matches the authentication information in the received packet.

Techniques related to IPsec are described in Japanese National Publication of International Patent Application No. 2008-541504 and Japanese Laid-open Patent Publication No. 2010-273225.

### SUMMARY

A communication device for transmitting and receiving packets, the communication device includes, a plurality of authentication generation processing units, which are respectively associated with different sequence number groups each including successive sequence numbers and which execute, in parallel, authentication generation processes for generating authentication information included in the packets based on sequence numbers allocated to the packets, a transmitting unit which transmits packets including the allocated sequence numbers to another communication device in an order in which authentication generation processes by the plurality of authentication generation processing units are completed, a receiving unit which receives a packet from the other communication device, and an authentication processing unit which executes a first authentication process in which the reception packet is authenticated based on a relationship between a sequence number of the reception packet and a sequence number of a preceding reception packet, wherein the preceding reception packet is received before the reception packet, and has a sequence number that belongs to a sequence number group to which a sequence number of the reception packet belongs.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a communication system 10.

FIG. 2 is a diagram illustrating a configuration example of a communication device 200.

FIG. 3 is a diagram illustrating an example of a format of a packet to be transmitted or received.

FIG. 4 is a diagram illustrating an example of the sequence number group information table 225.

FIG. 5 is a diagram illustrating an example of the per-sequence number group reception packet management table 226.

FIG. 6 is a diagram illustrating an example of a sequence of packet transmission/reception in a communication device.

FIG. 7 is a diagram illustrating an example of a processing flow chart of the transmitting-side session establishment process (S11) and the receiving-side session establishment process (S13).

FIG. 8 is a diagram illustrating an example of a processing flow chart of the authentication generation process.

FIG. 9 is a diagram illustrating an example of a processing flow chart of the packet transmission process.

FIG. 10 is a diagram illustrating an example of a processing flow chart of the packet reception process.

FIG. 11 is a diagram illustrating an example of a processing flow chart of the packet authentication process.

FIG. 12 is a diagram illustrating an example of a time chart of packet transmission.

FIG. 13 is a diagram illustrating an example of a comparative time chart of packet transmission of a comparison object system and the system according to the first embodiment.

FIG. 14 is a diagram illustrating a configuration example of the communication device 200.

FIG. 15 is a diagram illustrating an example of the data size information table 227.

FIG. 16 is a diagram illustrating an example of a time chart of packet transmission.

FIG. 17 is a diagram illustrating an example of a sequence in which a communication device receives a packet.

FIG. 18 is a diagram illustrating an example of a processing flow chart of the packet authentication process.

FIG. 19 is a diagram illustrating a configuration example of the communication device 200.

FIG. 20 is a diagram illustrating an example of the sequence number group information table 225.

FIG. 21 is a diagram illustrating an example of a time chart of a decrypting process which is executed when receiving a packet.

FIG. 22 is a diagram illustrating an example of a time chart of a decrypting process which is executed when receiving a packet.

### DESCRIPTION OF EMBODIMENTS

A process of encrypting data and generating authentication information based on the encrypted data and a sequence number (hereinafter, referred to as an authentication generation process) involves large amounts of arithmetic processing and memory accesses and consumes a long processing time. In addition, the larger a data size of a packet, the longer the processing time.

In consideration thereof, a communication device capable of reducing a transmission time of a packet is provided.

<Configuration of Communication System>

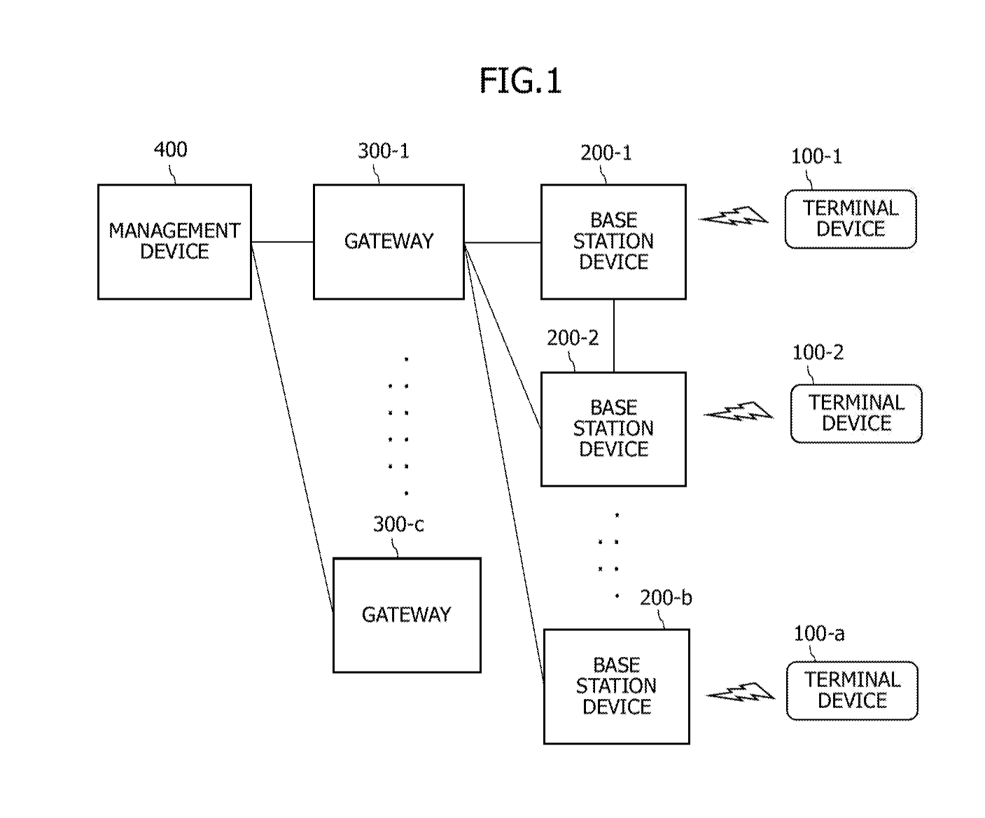

FIG. 1 is a diagram illustrating a configuration example of a communication system 10. The communication system 10 includes terminal devices 100-1 to 100-a, base station devices 200-1 to 200-b, gateways 300-1 to 300-c, and a management device 400. The communication system 10 is a communication system which provides the terminal devices 100-1 to 100-a with communication to enable the terminal devices 100-1 to 100-a to, for example, receive services of networks such as the Internet. The communication system 10 is a communication system which conforms to, for example, the Long Term Evolution (LTE) communication standard.

When the terminal device 100 receives a service, for example, the terminal device 100 communicates with the Internet (not illustrated) which is connected to the management device 400. The base station device 200, the gateway 300, and the management device 400 realize communication of the terminal device 100 by relaying packets transmitted and received by the terminal device 100. The management device 400, the gateway 300, and the base station device 200 are connected to each other via a dedicated line or a network such as an intranet. The terminal device 100 and the base station device 200 communicate with each other in a wireless manner.

As described above, communication devices constituting the communication system 10 communicate with the Internet. Since the Internet is an open network, packets via the Internet are at risk of data tampering or being exploited by a third party. In consideration thereof, there are cases where a communication device performs communication to which a protocol (such as IPsec) having data tampering prevention and secrecy functions is applied. With communication employing IPsec, security is improved by performing an authentication process using a sequence number which indicates a transmission order of packets and by encrypting a data part.

In IPsec, when a communication device transmits a packet, the communication device executes an authentication generation process of encrypting a data part and generating authentication information based on the encrypted data part and a sequence number. When the authentication generation process is performed in an order of sequence numbers, until the authentication generation process of a packet with a smaller sequence number is completed and the packet is transmitted, the authentication generation process of a packet to be transmitted next is not able to be executed and a waiting time is generated. Even when a plurality of authentication generation processes are performed in parallel, a waiting time until the authentication generation process of a packet with a smaller sequence number is completed and the packet is transmitted is generated. The waiting time is a period in which a packet is not transmitted and corresponds to a delay in packet transmission.

In consideration thereof, a communication device in the communication system 10 includes a plurality of authentication generation processing units which execute authentication generation processes in parallel. Each of the plurality of authentication generation processing units is associated with a sequence number group including successive sequence numbers. Each of the plurality of authentication generation processing units allocates, to a packet to be transmitted, a sequence number included in the sequence number group with which the authentication generation processing unit is associated. In addition, a receiving-side communication device manages a sequence number of a received packet for each sequence number group and performs authentication.

In other words, a range of usable sequence numbers is determined for each authentication generation processing unit, and a transmission order of packets to be transmitted by each authentication processing unit conforms to an order of the sequence numbers. In addition, by managing sequence numbers for each sequence number group, the receiving-side communication device can execute authentication based on sequence numbers for each sequence number group. Accordingly, a packet can be transmitted without having to wait for another authentication generation processing unit to complete an authentication generation process.

Hereinafter, while the base station device 200 will be described as an example of a communication device, the management device 400, the gateway 300, and the terminal device 100 may also become communication devices.

### First Embodiment

First, a first embodiment will be described. The communication device includes a plurality of authentication generation processing units, which are associated with different sequence number groups each including successive sequence numbers. The plurality of authentication generation processing units execute, in parallel, authentication generation processes for generating authentication information to be included in a packet based on a sequence number allocated to the packet. In addition, the communication device includes a transmitting unit which transmits a packet including an allocated sequence number to another communication device, in an order in which the authentication generation processes by the plurality of authentication generation processing units are completed. Furthermore, the communication device includes a receiving unit which receives a packet from another communication device. Furthermore, a first authentication process is executed in which authentication of a reception packet is performed based on a relationship between a sequence number of a preceding reception packet having been received before the reception packet in a sequence number group to which a sequence number of the reception packet belongs and the sequence number of the reception packet.

<Configuration Example of Communication Device>

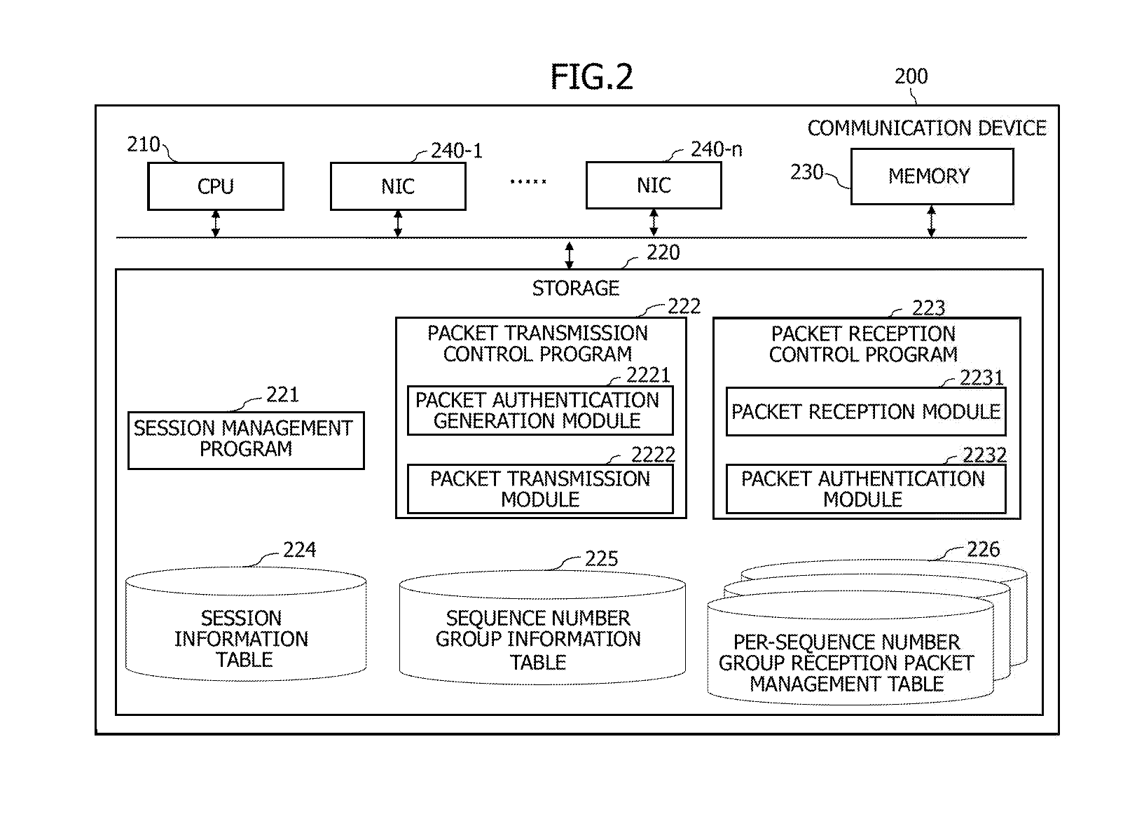

FIG. 2 is a diagram illustrating a configuration example of a communication device 200.

The communication device 200 includes a central processing unit (CPU) 210, a storage 220, a memory 230, and network interface cards (NICs) 240-1 to 240-n. The communication device 200 is a device which transmits and receives packets to and from another communication device.

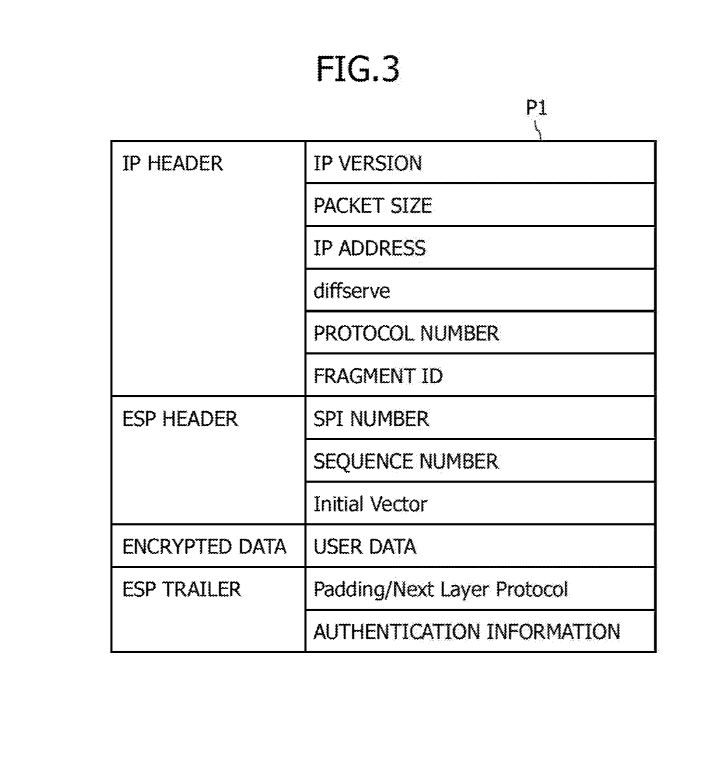

FIG. 3 is a diagram illustrating an example of a format of a packet to be transmitted or received. A packet P1 includes an Internet Protocol (IP) header, an Encapsulating Security Payload (ESP) header, encrypted data, and an ESP trailer as information elements. The IP header is a header containing information related to IP and includes an IP version, a packet size, an IP address, and a protocol number for identifying a protocol of a high-order layer. In addition, the IP header contains diffserv which includes a differentiated services code point (DSCP) for determining a quality of service (QoS) class and a fragment ID which is an identifier of a packet obtained by dividing the packet.

The ESP header contains a sequence number and an Initial Vector which is a random value. In addition, the ESP header includes a Security Parameter Index (SPI) number which represents a different numerical value for each session and which is an identifier of the session.

The encrypted data is a data area created by encrypting a user data area (or a payload area). Using an encryption key shared by both transmitting and receiving sides, data encrypted by the transmitting side is decrypted by the receiving side.

The ESP trailer contains information on Padding or a Next Layer Protocol, and authentication information. Authentication information is generated based on information contained in the ESP header and on encrypted data. In addition, authentication information is, for example, an integrity check value (ICV) attached to the packet in IPsec.

Next, each of the devices included in the communication device 200 will be described. The storage 220 is an auxiliary storage device which stores programs and data. The storage 220 stores a session management program 221, a packet transmission control program 222, a packet reception control program 223, a session information table 224, a sequence number group information table 225, and a per-sequence number group reception packet management table 226.

The session information table 224 is a table which stores information related to a session in communication with a communication device that is a packet transmission destination. Examples of stored information elements include an SPI number, an encryption key, and an authentication key. The communication device 200 is capable of simultaneously having a plurality of sessions in order to transmit and receive packets and communicate with a plurality of communication devices. In this case, the session information table 224 has a table for each SPI number. The session information table 224 is generated upon acquiring an SPI number and, when communication with the SPI number is terminated and a session is released, the session information table 224 of the SPI number is deleted.

The sequence number group information table 225 is a table which stores sequence numbers included in each of a plurality of sequence number groups.

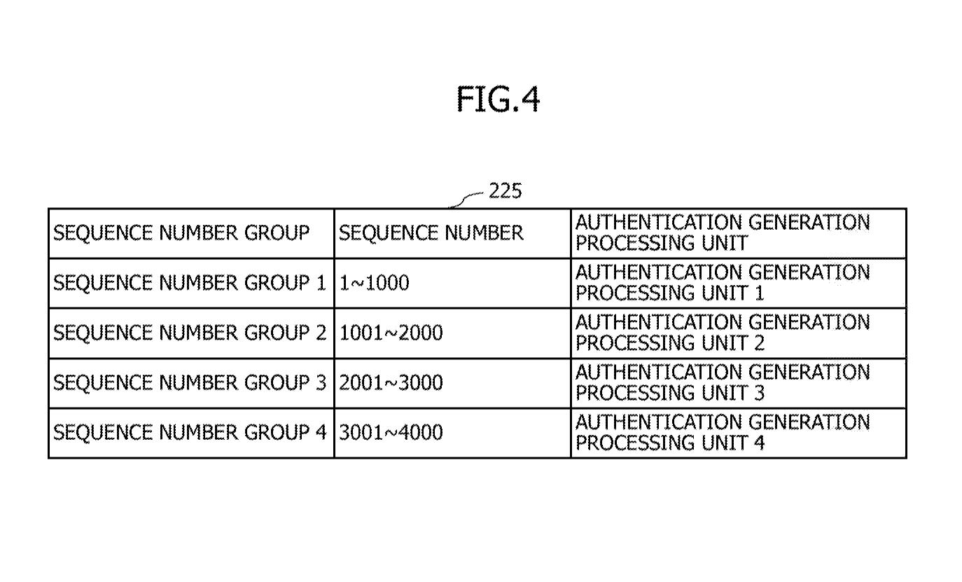

FIG. 4 is a diagram illustrating an example of the sequence number group information table 225. Information elements stored in the sequence number group information table 225 include a “sequence number group”, a “sequence number”, and an “authentication generation processing unit”. The “sequence number group” is, for example, information for identifying a sequence number group and is information in the form of a name such as “sequence number group 1” or an identifier of the sequence number group. The “sequence number” is information indicating a range of sequence numbers belonging to a sequence number group. The “authentication generation processing unit” is information for identifying an authentication generation processing unit associated with a sequence number group and is information in the form of a name such as “authentication generation processing unit 1” or an identifier of the authentication generation processing unit. The sequence number group information table 225 is stored in the communication device by, for example, a system administrator of the communication system 10 via a console computer.

The per-sequence number group reception packet management table 226 is a table which stores a sequence number of a received packet for each of the plurality of sequence number groups.

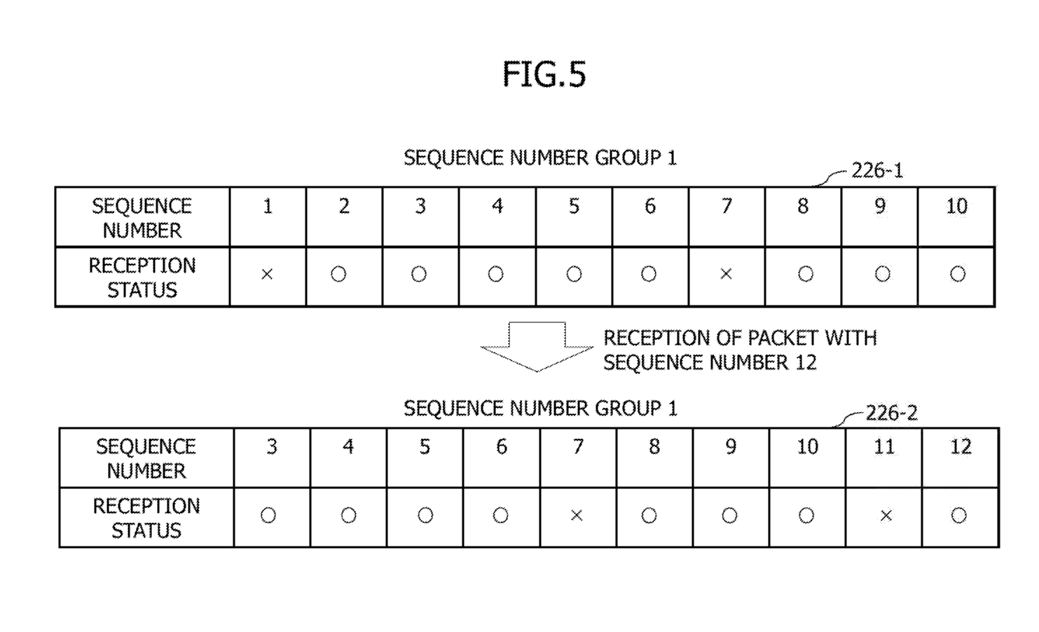

FIG. 5 is a diagram illustrating an example of the per-sequence number group reception packet management table 226. FIG. 5 illustrates a table of the sequence number group 1, in which an upper half of FIG. 5 is a diagram representing a per-sequence number group reception packet management table 226-1 before receiving a packet with a sequence number 12 and a lower half of FIG. 5 is a diagram representing a per-sequence number group reception packet management table 226-2 after receiving the packet with the sequence number 12.

The per-sequence number group reception packet management table 226 stores packet reception history of, for example, 10 packets. A corresponding “reception status” is stored for each “sequence number”, in which a packet with a sequence number of which the “reception status” is “x” has not been received while a packet with a sequence number of which the “reception status” is “o” has already been received. The per-sequence number group reception packet management table is, for example, a replay window which exists for each sequence number group.

The per-sequence number group reception packet management table 226-1 manages packets with sequence numbers 1 to 10. Packets with sequence numbers 1 and 7 are yet to be received.

In addition, when the communication device 200 receives the packet with the sequence number 12, the communication device 200 updates the per-sequence number group reception packet management table 226-1 to the per-sequence number group reception packet management table 226-2. Management objects of the per-sequence number group reception packet management table 226-2 range from 12 which is a latest sequence number to 3 which is a sequence number preceding the latest sequence number by 10 sequence numbers. In this manner, the per-sequence number group reception packet management table 226 manages reception history of a prescribed number of packets from the latest received sequence number.

The memory 230 is an area to which the programs stored in the storage 220 are loaded. In addition, the memory 230 is also used as an area in which the programs store data.

The NICs 240-1 to 240-n are devices which are connected to and communicate with other communication devices in a wireless or wired manner. The NICs 240-1 to 240-n may be connected to other communication devices via a hub or a switch.

The CPU 210 is a processor which loads the programs stored in the storage 220 to the memory 230, executes the loaded programs, and realizes respective processes.

By executing the session management program 221, the CPU 210 constructs a session management unit and realizes functions of the session management unit. The session management unit establishes sessions with other communication devices and manages the sessions. When the communication device starts transmission of a packet to another communication device, the session management unit executes a transmitting-side session establishment process for establishing a session. In addition, when the communication device starts reception of a packet from another communication device, the session management unit executes a receiving-side session establishment process.

In the transmitting-side session establishment process, the communication device 200 attaches an issued SPI number, candidates of adoptable sequence number systems, and the like to a Security Association (SA) establishment request, and transmits the SA establishment request to a communication device that is a transmission destination. Examples of a sequence number system include a system in which sequence numbers are used without being divided into sequence number groups and a system in which sequence numbers are used after being divided into sequence number groups. Examples of a sequence number system also include extended sequence number systems. In addition, the communication device 200 acquires an encryption key, an authentication key, a sequence number system adopted by the communication device that is a transmission destination, and the like contained in an SA establishment response to the SA establishment request, and stores the acquired information in the session information table 224. Furthermore, in the receiving-side session establishment process, the communication device 200 adopts a sequence number system, attaches the adopted sequence number system to an SA establishment response, and transmits the SA establishment response to the communication device that is a transmission source.

In addition, the CPU 210 realizes a packet transmission control process by executing the packet transmission control program 222 and each of the modules included in the packet transmission control program 222. The packet transmission control program 222 includes a packet authentication generation module 2221 and a packet transmission module 2222.

The CPU 210 constructs an authentication generation processing unit and realizes an authentication generation process by executing the packet authentication generation module 2221. When constructing a plurality of authentication generation processing units, for example, the packet authentication generation module 2221 is executed a plurality of times or the packet authentication generation module 2221 is executed using the number of authentication generation processing units to be constructed as an argument. Alternatively, for example, each of the plurality of authentication generation processing units may be realized by a dedicated accelerator or a dedicated CPU. The authentication generation process is a process of encrypting a data part of a packet to be transmitted and generating authentication information based on the encrypted data part and a sequence number. In the authentication generation process, a corresponding sequence number group is read from the sequence number group information table 225 and a sequence number is allocated to the packet subjected to authentication generation from the corresponding sequence number group.

The CPU 210 constructs a transmitting unit and realizes a packet transmission process by executing the packet transmission module 2222. The packet transmission process is a process of transmitting packets in an order in which authentication generation processes are completed.

Furthermore, the CPU 210 realizes a packet reception control process by executing the packet reception control program 223 and each of the modules included in the packet reception control program 223. The packet reception control program 223 includes a packet reception module 2231 and a packet authentication module 2232.

The CPU 210 constructs a receiving unit and realizes a packet reception process by executing the packet reception module 2231. The packet reception process is a process of receiving a packet transmitted from another communication device and notifying the authentication processing unit that a packet is received.

The CPU 210 constructs an authentication processing unit and realizes a packet authentication process by executing the packet authentication module 2232. The packet authentication process includes a first authentication process which involves authenticating a received packet when a difference between a sequence number of the received packet and a sequence number of an already-received packet having a latest sequence number is within a prescribed value. An example of the prescribed value is the number of reception packets managed by the per-sequence number group reception packet management table 226. When the communication device receives a packet with a sequence number that is older than an oldest sequence number managed by the per-sequence number group reception packet management table 226, the communication device determines that the received packet is an unauthorized packet and discards the received packet.

In addition, the packet authentication process includes a second authentication process which involves generating authentication information based on the sequence number and the encrypted data of the received packet, determining whether or not the generated authentication information matches the authentication information in the received packet, and authenticating the packet when the pieces of authentication information match each other. The second authentication process is executed on, for example, packets having passed the first authentication process. Furthermore, the packet authentication process may include a decrypting process of decrypting encrypted data of a packet having passed the second authentication process.

<Packet Transmission/Reception Process>

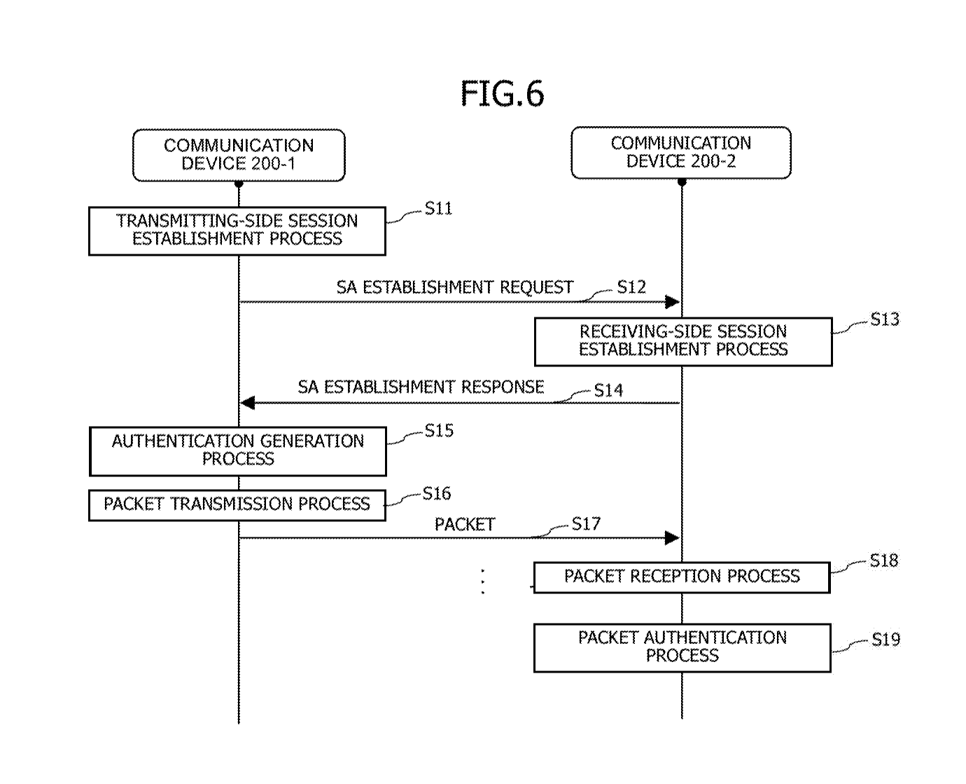

FIG. 6 is a diagram illustrating an example of a sequence of packet transmission/reception in a communication device. Hereinafter, a case where a packet is transmitted from the communication device 200-1 to the communication device 200-2 will be described with reference to FIG. 6.

When the communication device 200-1 starts transmission of a packet to the communication device 200-2, the communication device 200-1 executes the transmitting-side session establishment process (S11). In addition, the communication device 200-2 that is a transmission destination of the packet receives an SA establishment request and executes the receiving-side session establishment process (S13).

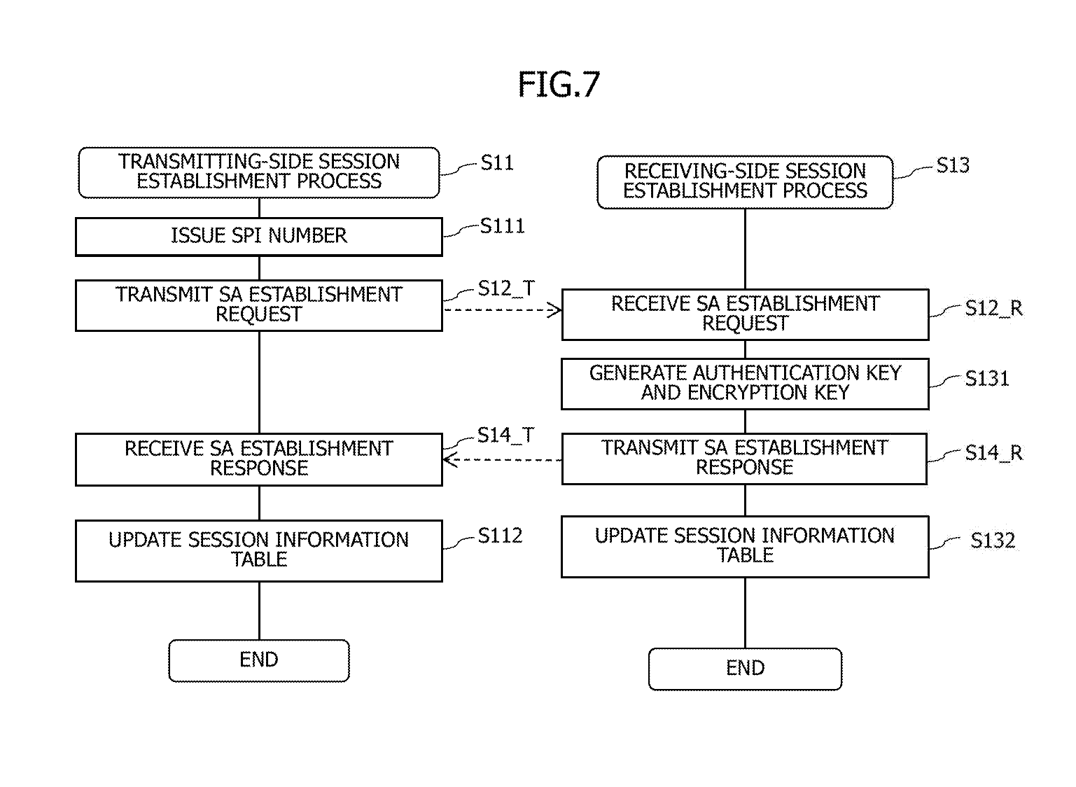

FIG. 7 is a diagram illustrating an example of a processing flow chart of the transmitting-side session establishment process (S11) and the receiving-side session establishment process (S13). In the transmitting-side session establishment process (S11), the communication device 200-1 issues an SPI number (S111). In the first embodiment, a sequence number group division system is adopted as the sequence number system. The sequence number group division system is a system involving dividing sequence numbers usable by a communication device into a plurality of different sequence number groups and managing sequence numbers for each sequence number group. In addition, the communication device 200-1 transmits an SA establishment request attached with an SPI number and information indicating that the adopted sequence number system is the sequence number group division system to the communication device 200-2 (S12).

In the receiving-side session establishment process (S13), when the communication device 200-2 receives the SA establishment request (S12), the communication device 200-2 generates an authentication key and an encryption key based on the SPI number included in the received SA establishment request (S131). The communication device 200-2 transmits an SA establishment response attached with the generated authentication key and encryption key and the adopted sequence number system to the communication device 200-1 (S14). In addition, the communication device 200-2 updates the session information table 224 (S132).

When the communication device 200-1 receives the SA establishment response (S14), the communication device 200-1 updates the session information table 224 (S112). Subsequently, the packet is transmitted and received using the session established by the processes described above.

The communication device 200-1 executes the authentication generation process (S15) on a packet to be transmitted. The authentication generation process is a process to be executed in parallel by a plurality of authentication generation processing units. For example, there are four authentication generation processing units respectively designated authentication generation processing units 1 to 4.

When data of the packet to be transmitted is generated, an authentication generation processing unit not executing the authentication generation process (hereinafter, referred to as an idle state) executes the authentication generation process of the packet to be transmitted. When there is a plurality of idle-state authentication generation processing units, any of the idle-state authentication generation processing units may execute the authentication generation process. In addition, when there is no idle-state authentication generation processing unit, it is waited until any of the authentication generation processing units enters an idle state and the authentication generation processing unit having entered the idle state executes the authentication generation process. Furthermore, in a case where data of a plurality of transmission packets is generated when there is no idle-state authentication generation processing unit, the authentication generation processing unit having entered the idle state executes authentication generation processes in an order of generation of the data of the transmission packets.

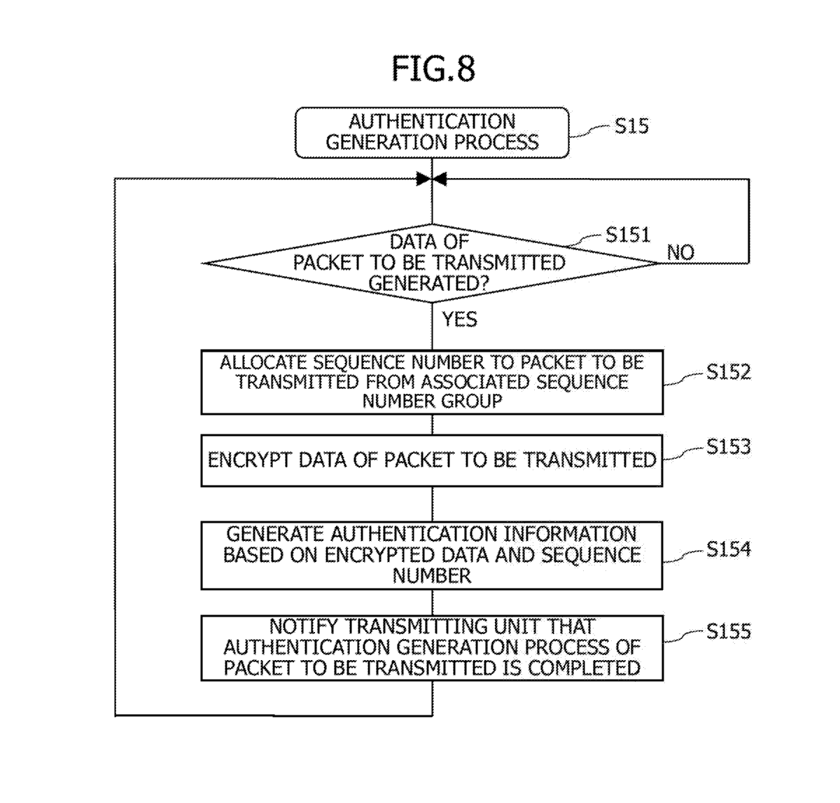

FIG. 8 is a diagram illustrating an example of a processing flow chart of the authentication generation process. Hereinafter, an example of a case where the authentication generation processing unit 1 of which a sequence number group has a correspondence illustrated in FIG. 4 executes the authentication generation process will be described.

In the authentication generation process (S15), monitoring is performed with respect to whether or not data of a packet to be transmitted is generated (S151). When data of the packet to be transmitted is generated (Yes in S151), the authentication generation processing unit 1 allocates a sequence number to the packet to be transmitted from the associated sequence number group (S152). The authentication generation processing unit 1 is associated with the sequence number group 1, and the sequence number group 1 includes sequence numbers 1 to 1000. As the sequence number, the authentication generation processing unit 1 allocates the number immediately following a previously-allocated sequence number. When there is no previously-allocated sequence number, 1 that is the smallest sequence number is allocated.

Subsequently, the data of the packet to be transmitted is encrypted (S153). For the encryption, the encryption key is used which is shared between the transmitting-side communication device and the receiving-side communication device and which had been transmitted and received during session establishment.

In addition, authentication information is generated based on the encrypted data and the allocated sequence number (S154). The authentication information is generated by a specific arithmetic operation using, for example, the authentication key which is shared between the transmitting-side communication device and the receiving-side communication device and which had been used to transmit and receive the SPI number, the sequence number, and the encrypted data during session establishment. Furthermore, the authentication information may be generated using a random number such as an Initial Vector.

The authentication generation processing unit 1 notifies the transmitting unit that the authentication generation process of the packet to be transmitted is completed (S155), and makes a transition to a state (for example, an idle state) of waiting for generation of data of the packet to be transmitted.

Returning to the sequence illustrated in FIG. 6, the transmitting unit having received the notification of completion of the authentication generation process of the packet from the authentication generation processing unit 1 executes the packet transmission process (S16).

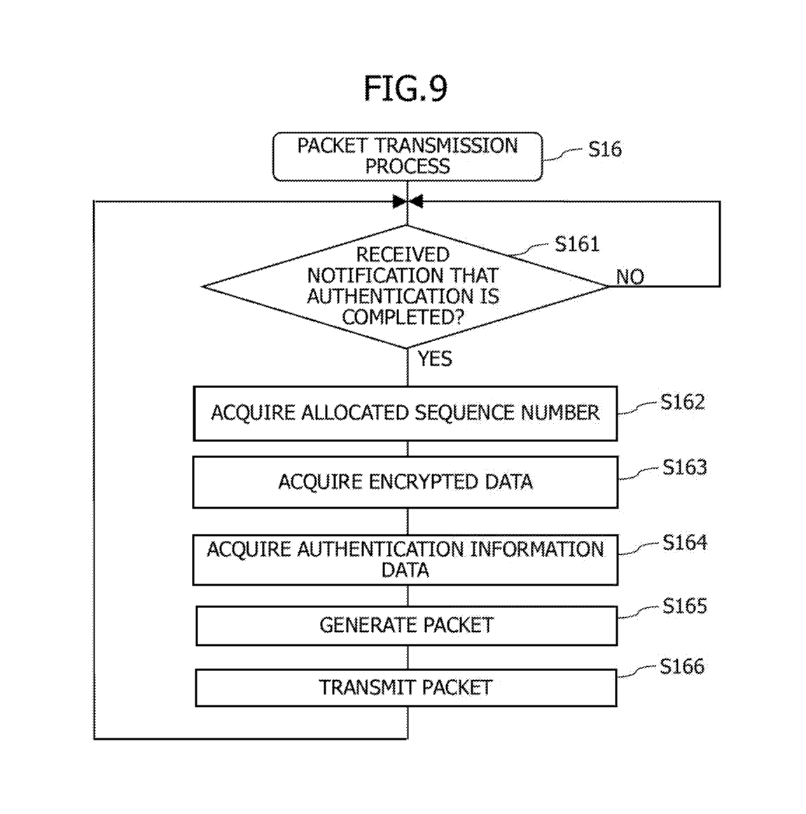

FIG. 9 is a diagram illustrating an example of a processing flow chart of the packet transmission process. When the transmitting unit receives a notification of completion of the authentication generation process (Yes in S161), the transmitting unit acquires the sequence number allocated to the packet to be transmitted (S162). For example, when the notification of completion of the authentication generation process includes the allocated sequence number, the sequence number is acquired from the notification. Alternatively, an inquiry may be made to the authentication generation processing unit. Alternatively, the authentication generation processing unit may store the allocated sequence number in the memory and the transmitting unit may read the stored information.

The transmitting unit acquires the encrypted data in a similar manner to the acquisition of the sequence number (S163), and acquires authentication information (S164). Subsequently, the transmitting unit generates a packet from the acquired information (S165), and transmits the generated packet to the communication device 200-1 (S166). When the transmission is completed, the transmitting unit checks whether or not a notification of completion of the authentication generation process is received (S161). When a notification is received (Yes in S161), the transmitting unit executes information acquisition to packet transmission, but when a notification is not received (No in S161), the transmitting unit waits for reception of a notification. In this manner, the transmitting unit waits for the authentication generation processes by the plurality of authentication generation processing units to be completed and transmits packets in an order in which the authentication generation processes of the packets are completed.

Returning to the sequence illustrated in FIG. 6, the packet is transmitted from the communication device 200-1 (S17) and the communication device 200-2 receives the transmitted packet. When receiving the packet, the receiving unit executes the packet reception process (S18).

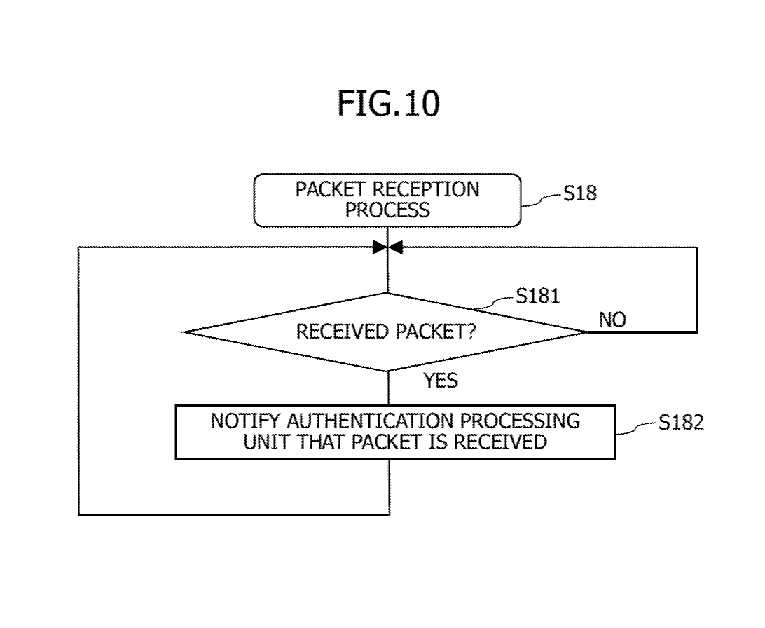

FIG. 10 is a diagram illustrating an example of a processing flow chart of the packet reception process. The receiving unit monitors whether or not a packet is received (S181). When a packet is received (Yes in S181), the receiving unit notifies the authentication processing unit that the packet is received (S182).

Returning to the sequence illustrated in FIG. 6, the authentication processing unit receives the notification indicating that the packet is received from the receiving unit and executes the packet authentication process (S19).

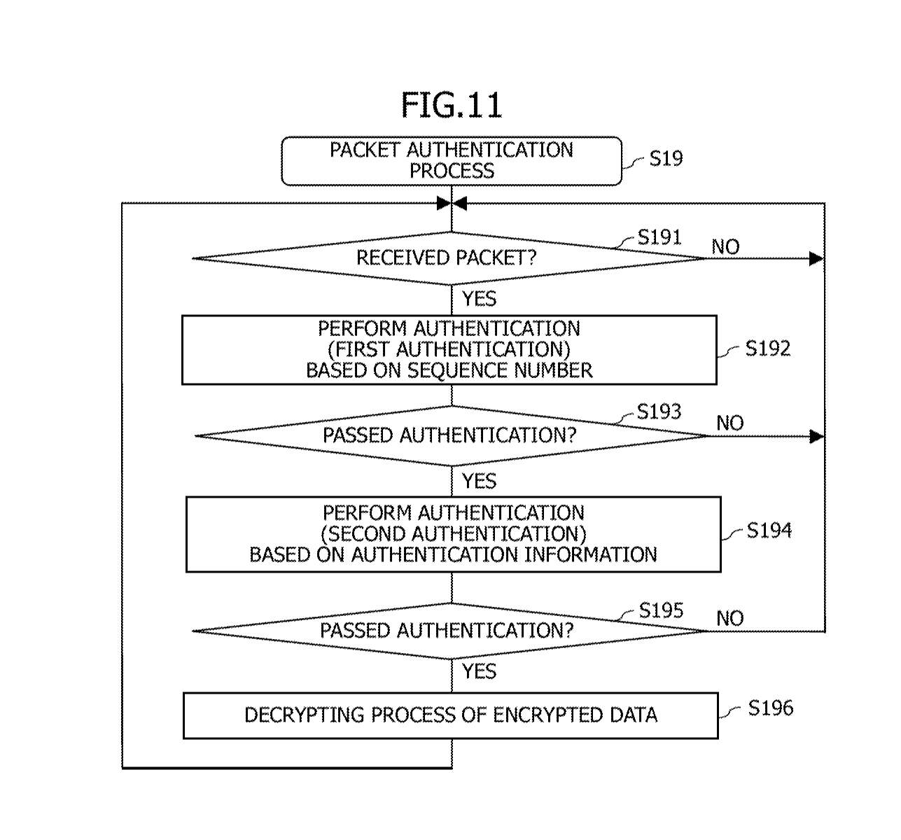

FIG. 11 is a diagram illustrating an example of a processing flow chart of the packet authentication process. The authentication processing unit monitors whether or not a packet is received (S191). Whether or not a packet is received is checked based on the presence or absence of a notification from the receiving unit. When a packet is received (Yes in S191), the authentication processing unit executes authentication (first authentication) based on a sequence number (S192).

The first authentication is authentication performed based on a relationship between the sequence number of the received packet and a sequence number of a previously-received packet. The first authentication is performed based on, for example, a difference (hereinafter, referred to as a sequence number difference) between a latest sequence number among the sequence numbers of already-received packets (also referred to as preceding reception packets) received prior to the presently received packet in the sequence number group to which the sequence number of the presently received packet belongs and the sequence number of the presently received packet. The sequence number difference is a number obtained by subtracting the sequence number of the received packet from the latest sequence number among the sequence numbers of the preceding reception packets and may have a negative value.

In the first authentication, when the sequence number difference is smaller than a first threshold, the received packet passes the authentication. For example, let us assume that the first threshold is 10, the sequence number of the received packet is 9, and the latest sequence number among the sequence numbers of the preceding reception packets is 10. In this case, since the sequence number difference is (10−9=) 1 which is smaller than the first threshold, the received packet passes the authentication. In addition, in the first authentication, even when the sequence number difference is smaller than the first threshold, a packet with a same sequence number as a preceding reception packet may be discarded instead of passing the authentication. Moreover, an example of the first threshold may be the number of packets of which history is managed by the per-sequence number group reception packet management table. Accordingly, when a packet with an older sequence number that is not managed by the per-sequence number group reception packet management table is received, the packet can be discarded instead of passing the authentication.

A case of the first authentication will be described in which it is assumed that the first threshold is the number of packets of which history is managed by the per-sequence number group reception packet management table and a packet with a same sequence number as a preceding reception packet does not pass the authentication. It is also assumed that the per-sequence number group reception packet management table is in the state of the per-sequence number group reception packet management table 226-2 illustrated in FIG. 5.

When a communication device receives a packet with a sequence number of 11, since the sequence number difference (12−11=) 1 is smaller than the first threshold 10 and the sequence number has not been previously received, the communication device allows the packet to pass the authentication. In addition, when the communication device receives a packet with a sequence number of 9, since the sequence number difference (12−9=) 3 is smaller than the first threshold 10 but the sequence number has already been received, the communication device does not allow the packet to pass the authentication. Furthermore, when the communication device receives a packet with a sequence number of 2, since the sequence number difference (12−2=) 10 is not smaller than the first threshold 10, the communication device does not allow the packet to pass the authentication. In addition, when the communication device receives a packet with a sequence number of 13, since the sequence number difference (12-13=) −1 is smaller than the first threshold 10 and the sequence number has not been previously received, the communication device allows the packet to pass the authentication.

Alternatively, as the sequence number difference, an absolute value of the difference between the latest sequence number among the sequence numbers of the preceding reception packets and the sequence number of the received packet may be adopted. In this case, even when the communication device receives a packet with a sequence number newer than the latest sequence number among the sequence numbers of the preceding reception packets, the communication device does not allow the received packet to pass the authentication and discards the received packet when the sequence number difference is equal to or larger than the first threshold.

As described above, in the first authentication, a latest sequence number among the sequence numbers of preceding reception packets is managed for each sequence number group and authentication is performed based on a sequence number difference from the received sequence number. Performing the first authentication enables an unauthorized packet to be discarded without having to perform processes with long processing times such as second authentication based on authentication information and a decrypting process to be described later.

In the packet authentication process (S19), when the received packet passes the first authentication (Yes in S193), authentication (second authentication) based on authentication information is performed (S194). The authentication processing unit generates authentication information by executing an arithmetic operation using an authentication key based on the sequence number, the encrypted data, the SPI number, and the like of the received packet. The authentication processing unit checks whether or not the generated authentication information and the authentication information included in the received packet match each other, and when the pieces of authentication information match each other, allows the received packet to pass the second authentication.

When the received packet passes the second authentication (Yes in S195), a decrypting process of the encrypted data of the received packet is performed (S196). Moreover, when the authentication processing unit does not execute the decrypting process, the communication device may construct a processing unit (a decryption processing unit) for executing the decrypting process and the decryption processing unit may execute the decrypting process.

<Packet Transmission Time Chart>

A time chart from the generation of data of a packet to be transmitted to the transmission of the packet by a communication device will now be described.

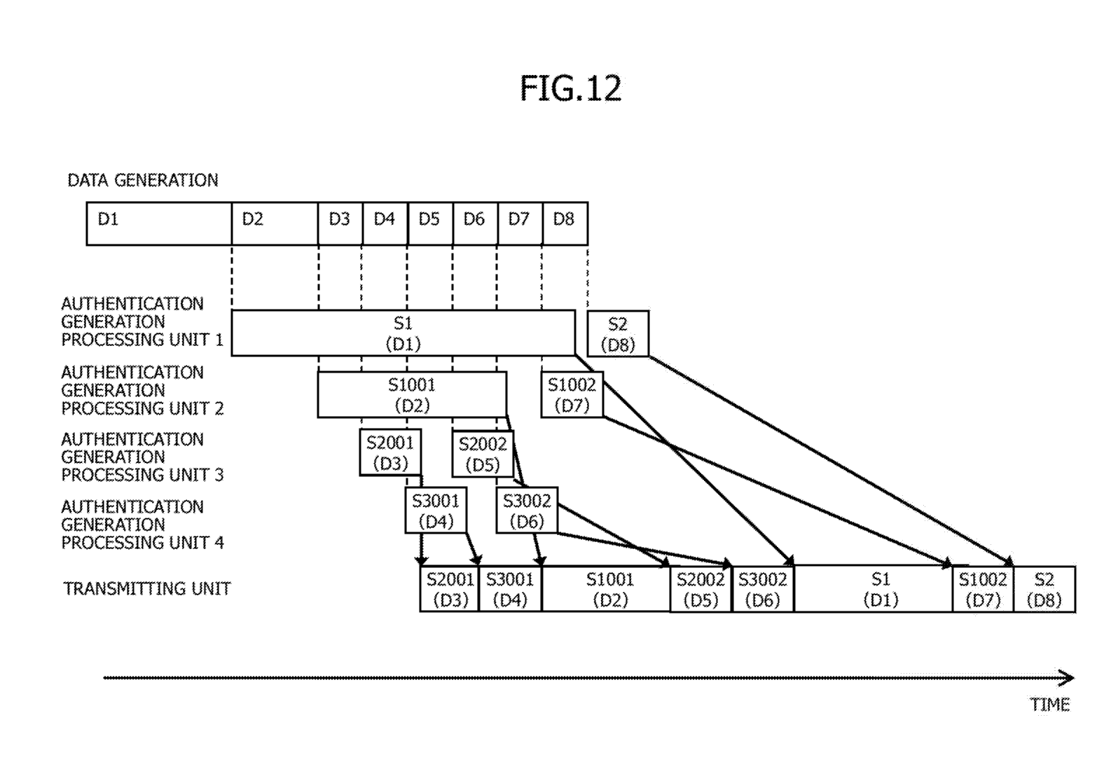

FIG. 12 is a diagram illustrating an example of a time chart of packet transmission. In FIG. 12, x in Dx (where x is a numeral) denotes a data number and y in Sy (where y is a numeral) denotes a sequence number. Hereinafter, data of which a data number is 1 will be expressed as data D1 and a sequence number of 1 will be expressed as S1. In addition, data D1 has a largest size among the pieces of data D1 to D8, and data D2 has a next largest size to the data D1. The pieces of data D3 to D8 have approximately similar data sizes. The communication device generates the pieces of data D1 to D8 as data of a packet. The pieces of data are generated in an order of the data numbers beginning with the data D1.

When the data D1 is generated, the authentication generation processing unit 1 in the idle state executes an authentication generation process of a packet in which the data D1 is to be transmitted. A sequence number 1 in a corresponding sequence number group is allocated to the packet.

Next, when the data D2 is generated, the authentication generation processing unit 2 in the idle state executes an authentication generation process of a packet in which the data D2 is to be transmitted. A sequence number 1001 in a corresponding sequence number group is allocated to the packet.

In a similar manner, the authentication generation processing units 3 and 4 execute authentication generation processes of packets in which the pieces of data D3 and D4 are to be transmitted.

At this point, the authentication generation processing units 1 to 4 are in a state of executing the authentication generation process (hereinafter, referred to as an executing state). The authentication generation process takes a longer time to perform when the size of the data subjected to authentication generation is larger. Therefore, the authentication generation process of the packet of the data D3 which had been started later but which has a small data size is completed first.

The transmitting unit transmits the packets in an order in which the authentication generation processes are completed. The transmitting unit transmits the packet with a sequence number 2001 of the data D3 of which the authentication generation process is completed first. Subsequently, the transmitting unit transmits the packet with a sequence number 3001 of the data D4 of which the authentication generation process is completed next.

In addition, when the data D5 is generated, since the authentication generation processing units 1 and 2 are in the executing state, the authentication generation processing unit 3 in the idle state executes the authentication generation process of a packet in which the data D5 is to be transmitted. Since the authentication generation processing unit 3 has allocated the sequence number 2001 to the packet for transmitting the data D3, the authentication generation processing unit 3 allocates 2002 which is the next sequence number in the corresponding sequence number group to the packet to be transmitted. In a similar manner, the authentication generation processing unit 4 executes the authentication generation process by allocating a sequence number 3002 to the packet in which the data D6 is to be transmitted.

When the transmitting unit completes transmission of the packets with the sequence numbers 2001 and 3001, the transmitting unit starts transmission of the packet with the sequence number 1001 of which the authentication generation process is completed by the authentication generation processing unit 2.

When the data D7 is generated, since the authentication generation processing unit 1 is in the executing state, the authentication generation processing unit 2 in the idle state executes the authentication generation process of a packet in which the data D7 is to be transmitted. Since the authentication generation processing unit 2 has allocated the sequence number 1001 to the packet for transmitting the data D2, the authentication generation processing unit 2 allocates 1002 which is the next sequence number in the corresponding sequence number group to the packet to be transmitted.

Subsequently, when the transmitting unit completes transmission of the packet with the sequence number 1001, the transmitting unit transmits the packet with the sequence number 2002 of which the authentication generation process is completed by the authentication generation processing unit 3. When the transmitting unit completes transmission of the packet with the sequence number 2002, the transmitting unit transmits the packet with the sequence number 3002 of which the authentication generation process is completed. Furthermore, when the transmitting unit completes transmission of the packet with the sequence number 3002, the transmitting unit transmits the packet with the sequence number 1 of which the authentication generation process is completed by the authentication generation processing unit 1. Thereafter, by repetitively performing similar processes, the packets with the sequence numbers 1002 and 2 are transmitted.

In the first embodiment, when data is generated, authentication generation processing units in the idle state perform authentication generation processes. In addition, packets are transmitted in an order in which the authentication generation processes are completed. In FIG. 12, while an order in which data is generated is from the data D1 to the data D8, the order in which the data is transmitted in packets is the order in which the authentication generation processes are completed, namely, the pieces of data D3, D4, D2, D5, D6, D1, D7, and D8.

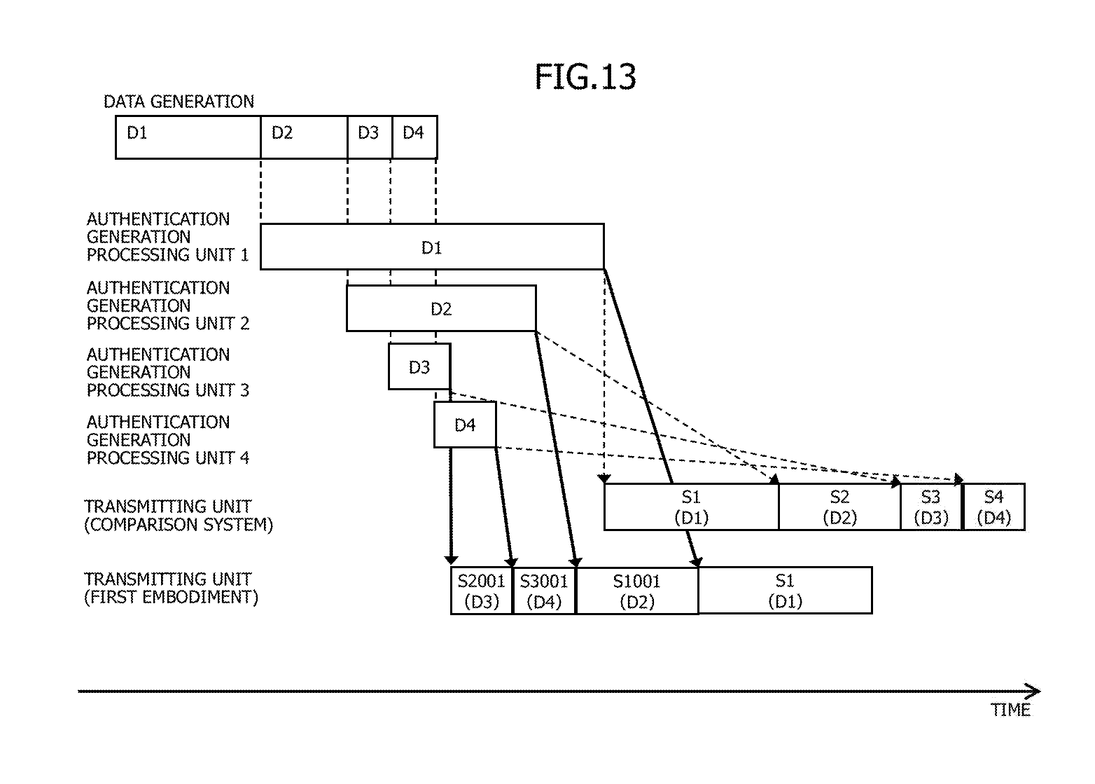

FIG. 13 is a diagram illustrating an example of a comparative time chart of packet transmission of a comparison object system and the system according to the first embodiment. It is assumed that data sizes are similar to those illustrated in FIG. 12.

The comparison object system is a system in which a plurality of authentication generation processing units execute authentication generation processes in parallel. In addition, in the comparison object system, sequence numbers are allocated in an order of data generation. Specifically, unlike the system according to the first embodiment, sequence number groups do not exist and a series of sequence numbers are allocated regardless of the authentication generation processing units executing authentication generation processes of packets.

A case where authentication generation processes are executed according to the comparison object system will now be described. The authentication generation processing units 1 to 4, respectively, execute authentication generation processes of packets in which pieces of data D1 to D4 are to be transmitted. Since the allocated sequence numbers are in the order of data generation, the data D1 is allocated a sequence number 1, the data D2 is allocated a sequence number 2, the data D3 is allocated a sequence number 3, and the data D4 is allocated a sequence number 4. Subsequently, the authentication generation process of the data D3 with a small data size is completed. However, when the authentication generation process of the data D3 is completed, since packets for the sequence numbers 1 and 2 have not yet been transmitted, the transmitting unit does not transmit the packet of the data D3 with the sequence number 3. In addition, even when authentication generation processes of the data D4 and the data D2 are completed, the transmitting unit does not transmit the packets for similar reasons. Subsequently, when the authentication generation process of the packet of the data D1 is completed, the transmitting unit transmits the packets in the order of sequence numbers.

Next, a case of the system according to the first embodiment will be described. The authentication generation processing units 1 to 4, respectively, execute authentication generation processes of packets in which pieces of data D1 to D4 are to be transmitted. Since the allocated sequence numbers are sequence numbers of corresponding sequence number groups, the data D1 is allocated a sequence number 1, the data D2 is allocated a sequence number 1001, the data D3 is allocated a sequence number 2001, and the data D4 is allocated a sequence number 3001. Subsequently, the authentication generation process of the data D3 with a small data size is completed. Since the transmitting unit transmits packets in the order in which the authentication generation processes are completed, the transmitting unit immediately transmits the packet for the sequence number 2001. Thereafter, packets are transmitted in the order in which the authentication generation processes are completed.

In the comparison object system, even when the authentication generation process of the data D3 is completed, packets are not transmitted until the authentication generation process of the data D1 with a large data size is completed. Therefore, as illustrated in FIG. 13, the transmission of all packets is completed at a later time than the system according to the first embodiment.

In the first embodiment, the plurality of authentication generation processing units included in a communication device are associated with different sequence number groups each including successive sequence numbers. When data to be transmitted is generated, each authentication generation processing unit allocates a sequence number included in the associated sequence number group to the packet to be transmitted and executes an authentication generation process. In addition, the transmitting unit transmits packets in an order in which the authentication generation processes are completed among the plurality of authentication processing units. Furthermore, the authentication processing units of the communication device perform a first authentication process in which authentication of a reception packet is performed based on a relationship between a sequence number of a preceding reception packet which has been received before the reception packet in a sequence number group to which a sequence number of the reception packet belongs and the sequence number of the reception packet.

Therefore, since the transmitting side transmits packets in the order in which authentication generation processes are completed, a packet with a second sequence number which is larger than a first sequence number but with a shorter authentication generation processing time can be transmitted before a packet with the first sequence number which has a longer authentication generation processing time. In addition, since the transmitting side performs authentication to check whether or not each packet is received in the order of sequence numbers for each of a plurality of sequence number groups, authentication in the order of sequence numbers can be applied.

Accordingly, during a transmission process of packets, the time to wait for completion of a packet authentication process of another authentication generation processing unit can be shortened and packet transmission time is reduced.

### Second Embodiment

Next, a second embodiment will be described.

In the second embodiment, each of a plurality of authentication generation processing units is associated with a data size of a packet to be transmitted. Each of the authentication generation processing units executes an authentication generation process of a packet with the associated data size.

### <Configuration Example of Communication Device>

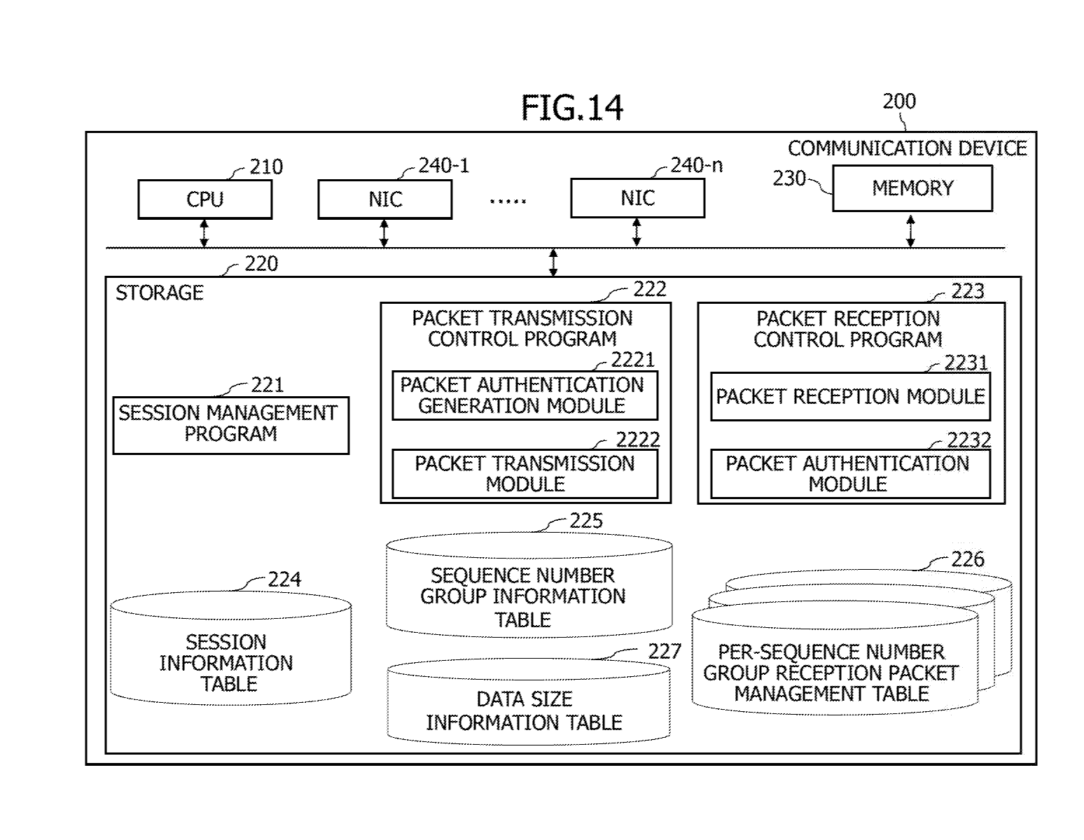

FIG. 14 is a diagram illustrating a configuration example of the communication device 200. The communication device 200 further includes a data size information table 227.

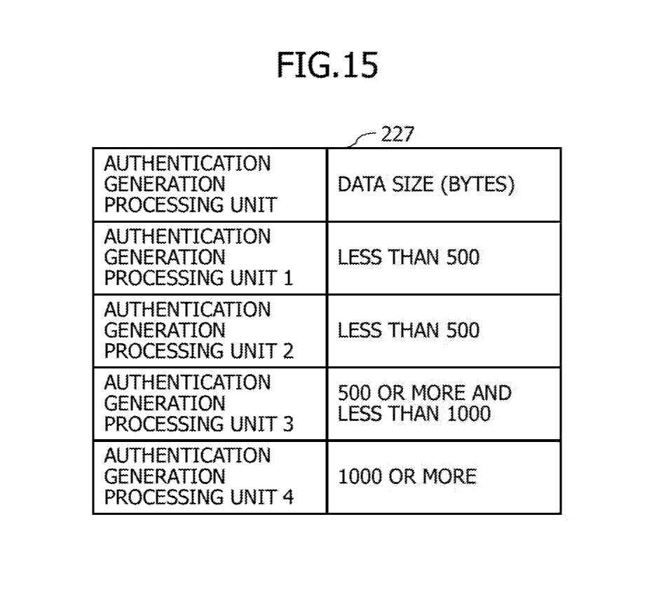

FIG. 15 is a diagram illustrating an example of the data size information table 227. Information stored in the data size information table 227 includes an “authentication generation processing unit” and a “data size (bytes)”. The “authentication generation processing unit” represents a name of an authentication generation processing unit corresponding to a data size. The “data size (bytes)” is a data size associated with an authentication generation processing unit. In FIG. 15, the authentication generation processing units 1 and 2 are associated with a data size of less than 500 bytes. In addition, the authentication generation processing unit 3 is associated with a data size of 500 bytes or more and less than 1000 bytes, and the authentication generation processing unit 4 is associated with a data size of 1000 bytes or more. A given data size may be associated with a plurality of authentication generation processing units. Furthermore, in FIG. 15, there are two authentication generation processing units associated with the data size of less than 500 bytes, which is larger than the number of authentication generation processing units associated with other data sizes. For example, let us assume that audio data in voice communication which needs a real-time property is a packet with a data size of less than 500 bytes. When all authentication generation processing units are in an executing state due to authentication generation processes of other large data sizes, transmission of the audio data is delayed. In consideration thereof, a small data size is associated with a large number of authentication generation processing units so that the authentication generation process of a packet of audio data can be preferentially executed.

<Packet Transmission Time Chart>

A time chart from the generation of data of a packet to be transmitted to the transmission of the packet by a communication device will now be described.

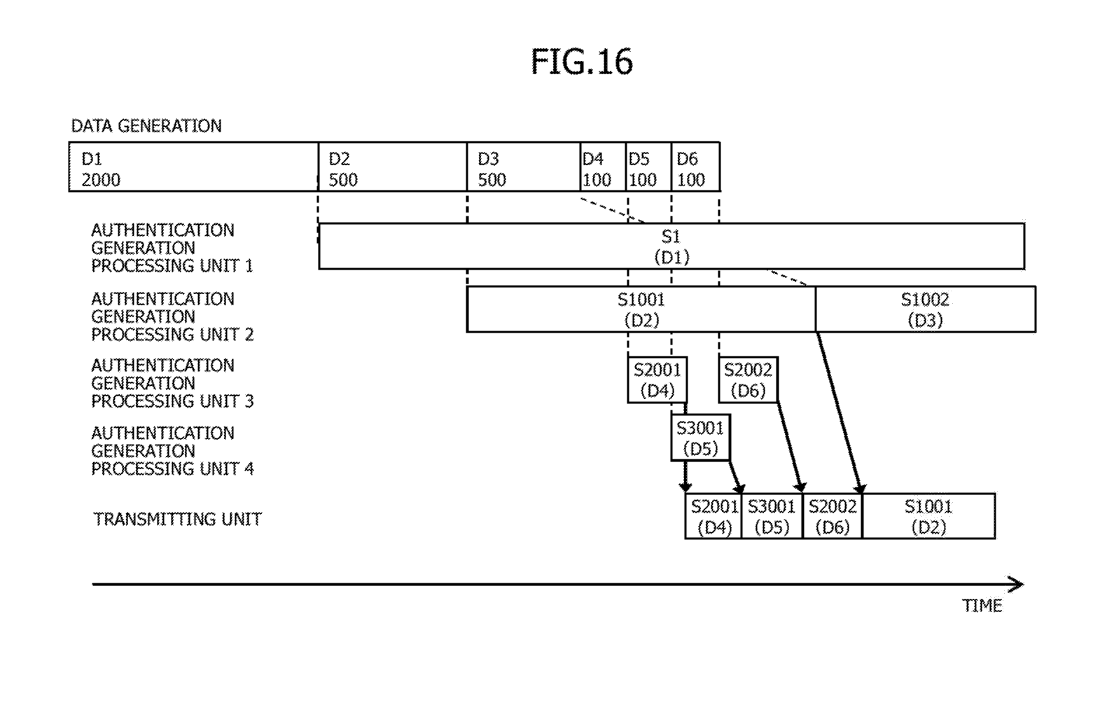

FIG. 16 is a diagram illustrating an example of a time chart of packet transmission. A numerical value below each piece of data indicates a size (bytes) of the data. In addition, the data size information table 227 illustrated in FIG. 15 will be described as an example.

The authentication generation processing unit 1 executes an authentication generation process of the packet of the data D1 with the associated data size. The authentication generation processing unit 2 executes an authentication generation process of the packet of the data D2 with the associated data size and, after completion of the authentication generation process of the packet of the data D2, executes an authentication generation process of the packet of the data D3. In addition, for packets of the pieces of data D4 to D6, the authentication generation processing units 3 and 4 with associated data sizes execute authentication generation processes.

The pieces of data D4 to D6 are, for example, audio data. Even when new audio data is generated subsequent to the data D6, the authentication generation processing units 3 and 4 are in the idle state. Therefore, when audio data is generated, the authentication generation processing unit 3 or 4 executes the authentication generation process of the audio data.

In the second embodiment, each of the plurality of the authentication generation processing units executes a packet authentication process of a packet with a data size to which the authentication generation processing unit is associated. The communication device includes one or a needed number of authentication generation processing units which perform an authentication generation process of data with a small data size but with high real-time property such as audio data (for example, equal to or less than 100 bytes) in voice communication. Accordingly, when audio data is generated, a risk that all of the authentication generation processing units are performing authentication generation processes of large data and are unable to perform authentication generation of the audio data can be mitigated and real-time property can be ensured.

### Third Embodiment

Next, a third embodiment will be described.

In the third embodiment, a receiving-side communication device in an initial state manages sequence numbers with one sequence number group. In addition, in accordance with a sequence number of a received packet, the receiving-side communication device divides the sequence number group and manages sequence numbers for each divided sequence number group.

<Sequence Number Group Division Process>

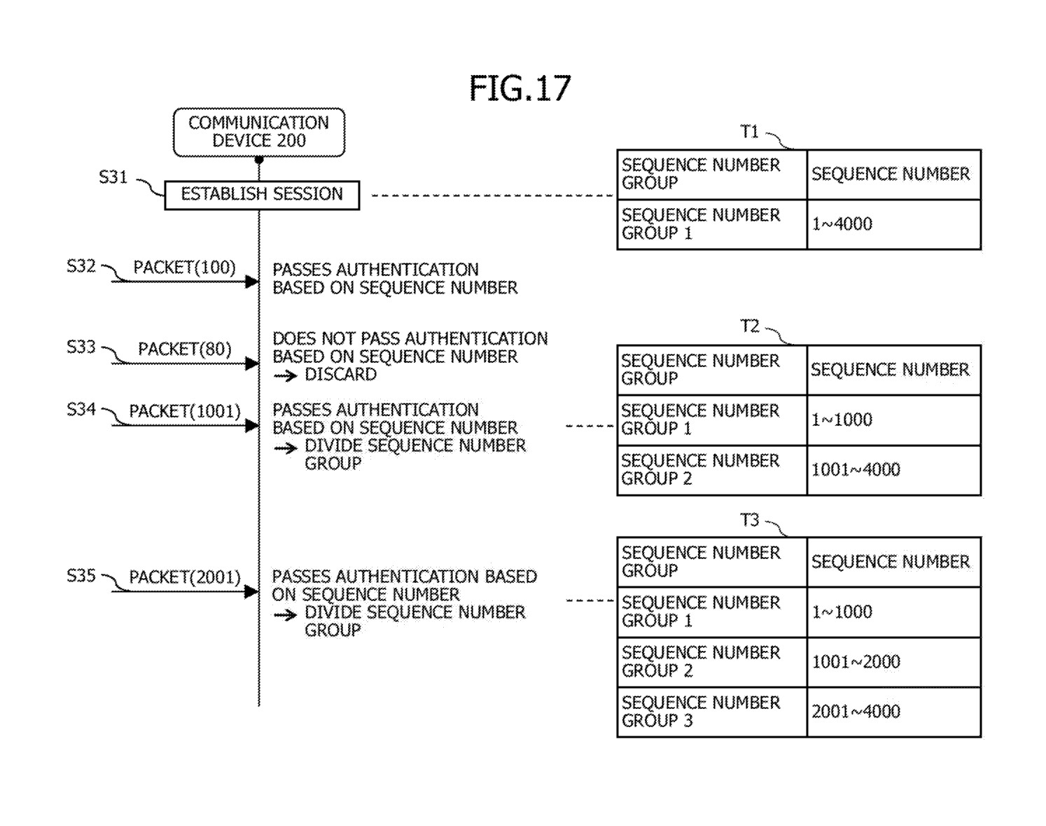

FIG. 17 is a diagram illustrating an example of a sequence in which a communication device receives a packet. FIG. 17 represents an example in which a sequence number group is divided in accordance with a sequence number of the received packet.

The communication device 200 establishes a session when starting communication (S31). When the session is established, the sequence number group information table 225 of the communication device 200 is in an initial state (T1).

When the communication device 200 receives a packet with a sequence number of 1 (a packet (1): hereinafter, similar expressions will be used) (S32), the communication device 200 executes a packet authentication process.

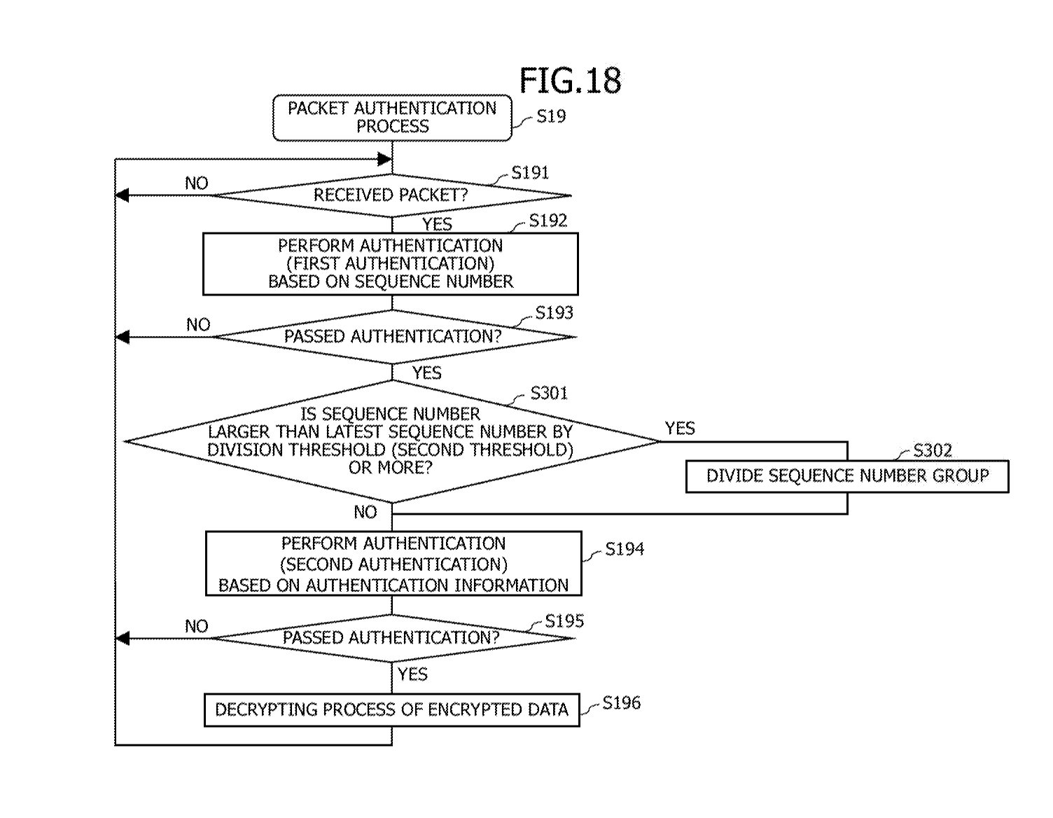

FIG. 18 is a diagram illustrating an example of a processing flow chart of the packet authentication process. The packet authentication process from receiving a packet (S191) to checking whether or not the packet has passed the first authentication process (S193) is similar to the packet authentication process according to the first embodiment illustrated in FIG. 11.

When the received packet passes sequence number-based authentication (Yes in S193), the communication device 200 checks whether or not the sequence number is larger than a latest sequence number by a division threshold (a second threshold) or more (S301). The second threshold is a numerical value larger than the first threshold and is a threshold for determining whether or not a sequence number group is to be divided. When the sequence number is larger than the latest sequence number by the second threshold or more (Yes in S301), the communication device 200 divides the sequence number group (S302). The sequence number group is divided at the sequence number of the received packet as a boundary. The sequence numbers are divided into two, for example, namely, a sequence number group including sequence numbers that are equal to or larger than the sequence number of the received packet and a sequence number group including sequence numbers that are smaller than the sequence number of the received packet. Alternatively, by also considering a case where an order of reception of packets is reversed, the division may be performed with a sequence number that is smaller than the sequence number of the received packet by a prescribed value (for example, 10) as a boundary. In the following description, it is assumed that the first threshold is 10 and the second threshold is 500.

Returning to the sequence illustrated in FIG. 17, when the communication device 200 receives the packet (1) (S32), since a sequence number difference is (0 (initial value)−100=) −100 which is smaller than the first threshold 10, the packet (1) passes the first authentication.

Next, when the communication device 200 receives the packet (80) (S33), since the sequence number difference is (100−80=) 20 which is not smaller than the first threshold 10, the received packet does not pass the first authentication and is discarded.

Next, when the communication device 200 receives the packet (1001) (S34), since the sequence number difference is (100−1001=) −901 which is smaller than the first threshold 10, the received packet passes the first authentication. In addition, since the sequence number 1001 of the received packet is larger than a latest sequence number 100 among the sequence numbers of preceding reception packets by the second threshold or more, the communication device 200 divides the sequence number group. The communication device 200 separates sequence numbers from the sequence number 1001 of the received packet to a largest sequence number 4000 in the sequence number group 1 as a sequence number group 2, from the sequence number group 1 prior to separation (T2).

Next, when the communication device 200 receives the packet (2001) (S35), since the sequence number difference is (1001-2001=) −1000 which is smaller than the first threshold 10, the received packet passes the first authentication. In addition, since the sequence number 2001 of the received packet is larger than a latest sequence number 1001 among the sequence numbers of the preceding reception packets by the second threshold or more, the communication device 200 divides the sequence number group. The communication device 200 separates sequence numbers from the sequence number 2001 of the received packet to a largest sequence number 4000 in the sequence number group 2 as a sequence number group 3, from the sequence number group 2 prior to separation (T3).

In the third embodiment, a communication device determines whether or not the sequence number of a received packet is larger than the latest sequence number by the second threshold or more. When larger by the second threshold or more, a new sequence number group is separated from the received sequence number group.

For example, when a frequency in which of packets are transmitted is low and authentication generation processes are not executed in an overlapping manner in the communication system, packets are transmitted and received with one sequence number group. However, when the transmission frequency of packets increases during the operation of the communication system, a plurality of authentication generation processing devices execute processes in parallel. In this case, the communication device divides the sequence number group into a plurality of sequence number groups and causes a plurality of authentication generation processing devices to process the plurality of sequence number groups. In consideration thereof, when the receiving side detects that a sequence number group is newly created on the transmitting side, the receiving side divides a new sequence number group from the received sequence number group and performs authentication of reception in the order of sequence numbers in the divided sequence number group. As described above, in the third embodiment, the number of sequence number groups can be increased in accordance with a change in a communication state of the communication system.

### Fourth Embodiment

Next, a fourth embodiment will be described.

In the fourth embodiment, a receiving-side communication device includes a plurality of decryption processing units which execute decrypting processes in parallel. The plurality of decryption processing units are associated with different sequence number groups, and a decryption processing unit associated with a sequence number group including a sequence number of a reception packet executes a decrypting process of encrypted data in the reception packet.

<Configuration Example of Communication Device>

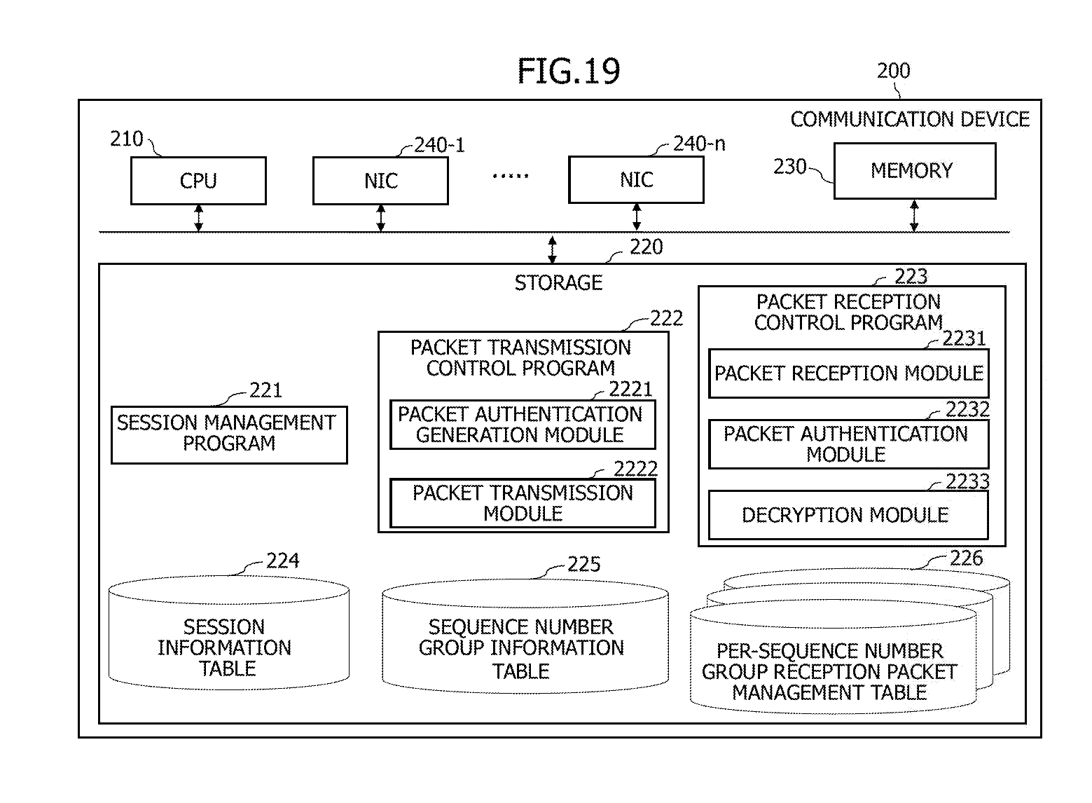

FIG. 19 is a diagram illustrating a configuration example of the communication device 200. The packet reception control program 223 further includes a decryption module 2233.

The CPU 210 constructs a decryption processing unit and realizes a decrypting process executed by the decryption processing unit by executing the decryption module 2233. The decrypting process is a process of decrypting encrypted data of a received packet and uses an encryption key that is shared between transmitting-side and receiving-side communication devices. When constructing a plurality of decryption processing units, for example, the decryption module 2233 is executed a plurality of times or the decryption module 2233 is executed using the number of decryption processing units to be constructed as an argument. Alternatively, each of the plurality of decryption processing units may be realized by a dedicated accelerator or a dedicated CPU.

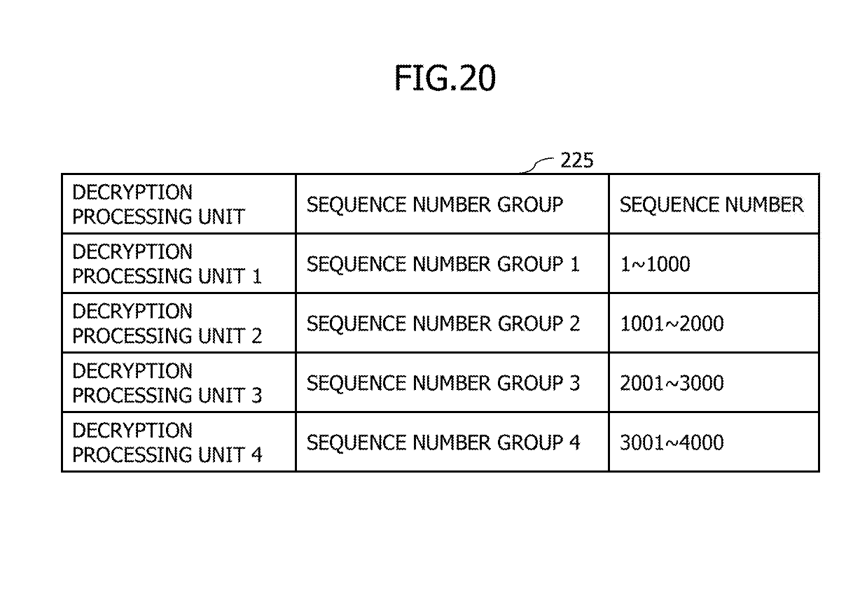

FIG. 20 is a diagram illustrating an example of the sequence number group information table 225. In the receiving-side communication device 200, a decryption processing unit and a sequence number group are associated with each other.

<Decrypting Process Upon Packet Reception>

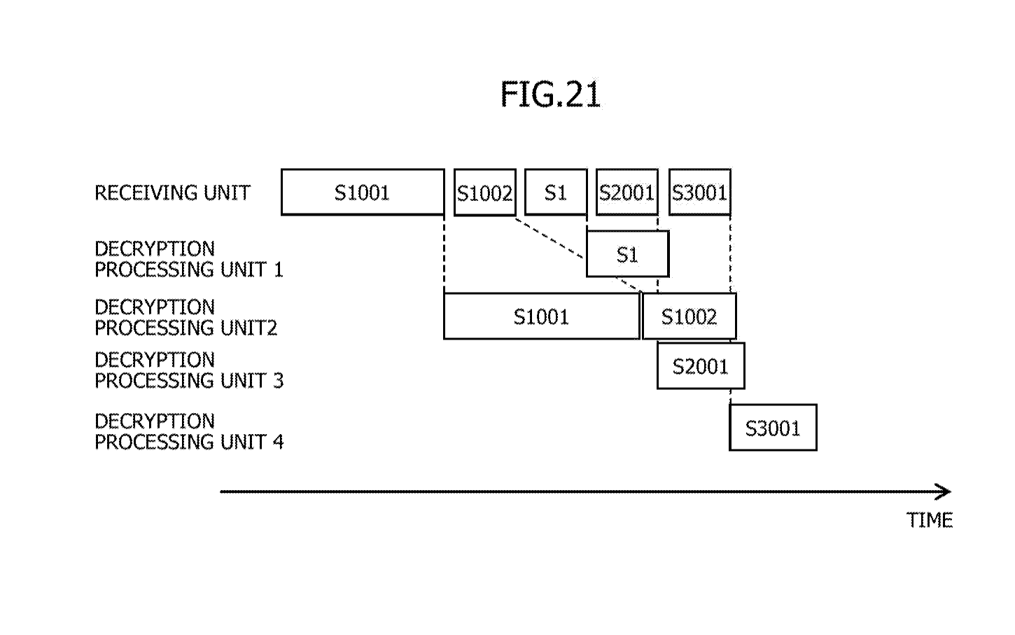

FIG. 21 is a diagram illustrating an example of a time chart of a decrypting process which is executed when receiving a packet. A case where decryption processing units are in correspondences illustrated in FIG. 20 will be described.

The receiving unit of the communication device receives packets in an order of sequence numbers 1001, 1002, 1, 2001, and 3001. Each decryption processing unit decrypts encrypted data of a packet of a sequence number group with which the decryption processing unit is associated.

The packet with the sequence number 1001 is subjected to a decrypting process executed by the decryption processing unit 2. While the next-received packet with the sequence number 1002 is subjected to a decrypting process executed by the decryption processing unit 2, since the decryption processing unit 2 is executing the decrypting process of the packet with the sequence number 1001, the decrypting process of the packet with the sequence number 1002 is executed after the decrypting process of the packet with the sequence number 1001 is completed. Decrypting processes of the packets with the sequence numbers 1, 2001, and 3001 are, respectively, executed by the idle-state decryption processing units 1, 3, and 4.

In the fourth embodiment, a communication device associates a plurality of decryption processing units to different sequence number groups. Accordingly, for example, the communication device can execute a decrypting process of data with high real-time property such as audio data as described in the second embodiment without waiting for a decrypting process of other data to be completed. As a result, real-time property can be secured.

<Modification of Decrypting Process Upon Packet Reception>

In a modification, a plurality of decryption processing units are not associated with sequence number groups and, when a packet is received, a decryption processing unit not executing a decrypting process (hereinafter, referred to as an idle state) executes a decrypting process.

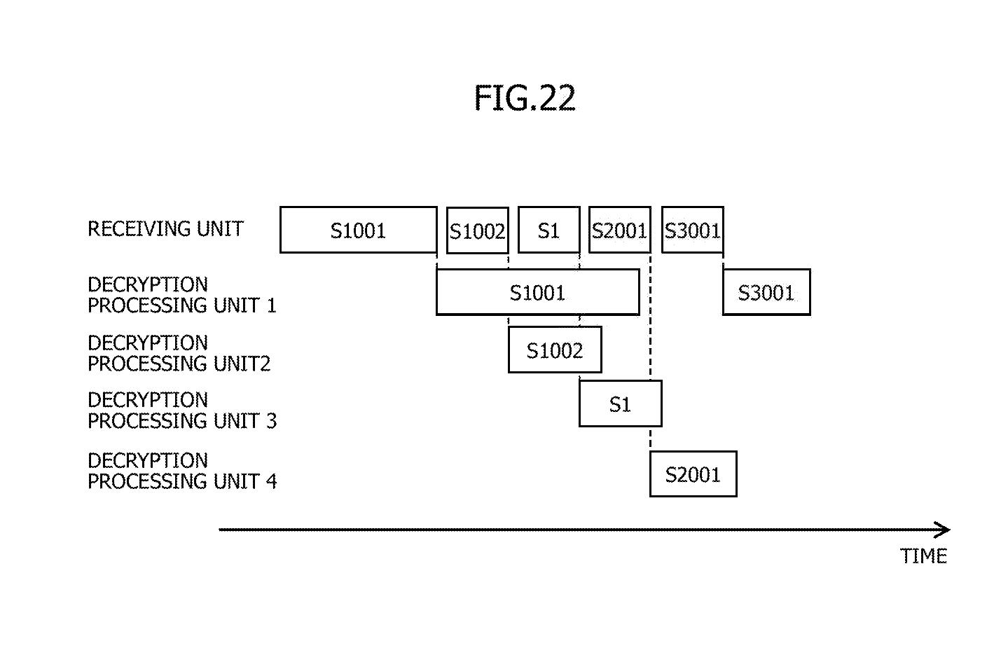

FIG. 22 is a diagram illustrating an example of a time chart of a decrypting process which is executed when receiving a packet. An order in which packets are received is similar to that illustrated in FIG. 21. Each decryption processing unit executes a decrypting process in the order in which the packet is received. When a plurality of decryption processing units are in the idle state, decrypting processes are executed in an ascending order of numbers assigned to the decryption processing units.

When a packet with a sequence number 1001 is received, since all decryption processing units are in the idle state, a decryption processing unit 1 executes a decryption process. When a packet with a sequence number 1002 is received, since the decryption processing unit 1 is executing a decrypting process, the decryption processing unit 2 executes a decryption process. In a similar manner, packets with the sequence numbers 1 and 2001 are, respectively, subjected to decrypting processes executed by the decryption processing units 3 and 4.

When a packet with a sequence number 3001 is received, since all decryption processing units with the exception of the decryption processing unit 4 are in the idle state, the decryption processing unit 1 executes a decryption process.

In the modification, a decryption processing unit in the idle state executes a decrypting process of a newly received packet. Accordingly, a period of time in which a decryption processing unit is in the idle state is shortened and a waiting time for a decrypting process of a reception packet is reduced. In other words, the time until the decrypting process of a received packet is completed can be shortened.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A communication device for transmitting and receiving packets, the communication device comprising:
a plurality of authentication generation processing units, which are respectively associated with different sequence number groups each including successive sequence numbers and which execute, in parallel, authentication generation processes for generating authentication information included in the packets based on sequence numbers allocated to the packets;
a transmitting unit which transmits packets including the allocated sequence numbers to another communication device in an order in which authentication generation processes by the plurality of authentication generation processing units are completed;
a receiving unit which receives a packet from the other communication device; and
an authentication processing unit which executes a first authentication process in which the reception packet is authenticated based on a relationship between a sequence number of the reception packet and a sequence number of a preceding reception packet,
wherein the preceding reception packet is received before the reception packet, and has a sequence number that belongs to a sequence number group to which a sequence number of the reception packet belongs.

2. The communication device according to claim 1, wherein
the relationship is a difference between a latest sequence number among sequence numbers of the preceding reception packets, and the sequence number of the reception packet.

3. The communication device according to claim 2, wherein
the authentication processing unit allows the reception packet to pass the first authentication process when the difference is less than a first threshold.

4. The communication device according to claim 1, wherein
the authentication generation process includes encrypting data of the transmission packet and generating the authentication information based on the encrypted data and the allocated sequence number, and
when the reception packet passes the first authentication process, the authentication processing unit further executes a second authentication process of authenticating the reception packet based on the authentication information and the sequence number of the reception packet,
and executes a decrypting process of decrypting the encrypted data of the reception packet when the reception packet passed the second authentication process.

5. The communication device according to claim 4, further comprising a plurality of decryption processing units which execute the decrypting processes in parallel, wherein
a decrypting process of the encrypted data of the reception packet is executed by any of the decryption processing units not executing the decrypting process.

6. The communication device according to claim 4, further comprising a plurality of decryption processing units which execute the decrypting processes in parallel, wherein
the decryption processing unit, which is respectively associated with a sequence number group including the sequence number of the reception packet, executes a decrypting process of the encrypted data of the reception packet.

7. The communication device according to claim 4, wherein
at least one of the plurality of authentication generation processing units is associated with a data size that differs from data sizes with which another authentication generation processing units are associated, and
each of the plurality of authentication generation processing units executes the authentication generation process of a packet with a data size associated with the authentication generation processing unit.

8. The communication device according to claim 7, wherein
the number of authentication generation processing units with which a first data size is associated is greater than the number of authentication generation processing units with which a second data size that is greater than the first data size is associated.

9. The communication device according to claim 3, wherein
when the difference is equal to or greater than the first threshold and the sequence number of the reception packet is greater than the latest sequence number among the sequence numbers of the preceding reception packets by a second threshold that is greater than the first threshold or more, the authentication processing unit further separates a sequence number group including sequence numbers from a minimum sequence number in a first sequence number group to which the reception packet belongs to a sequence number that is less than the sequence number of the reception packet as a second sequence number group, from the first sequence number group.

10. The communication device according to claim 1, wherein
when data of a packet to be transmitted to the other communication device is generated, any of the authentication generation processing units not executing the authentication generation process executes an authentication generation process of the generated data.

11. The communication device according to claim 1, wherein
each of the different sequence number groups does not include overlapping sequence numbers, and any of the different sequence number groups includes all sequence numbers usable by the communication device.

12. A non-transitory computer-readable storage medium storing therein a packet transmission/reception program for transmitting and receiving packets in a communication device, the packet transmission/reception program causing a computer to execute a process comprising:
executing, in parallel, a plurality of authentication generation processes, which are associated with different sequence number groups each including successive sequence numbers and which generate authentication information included in the packets based on sequence numbers allocated to the packets;
transmitting packets including the allocated sequence numbers to another communication device in an order in which the plurality of authentication generation processes are completed;
receiving a packet from the other communication device; and
executing a first authentication process in which the reception packet is authenticated based on a relationship between a sequence number of the reception packet and a sequence number of a preceding reception packet,
wherein the preceding reception packet is received before the reception packet, and has a sequence number that belongs to a sequence number group to which a sequence number of the reception packet belongs.

13. A method of transmitting and receiving packets in a communication device, the method comprising:
executing, in parallel, a plurality of authentication generation processes, which are associated with different sequence number groups each including successive sequence numbers and which generate authentication information included in the packets based on sequence numbers allocated to the packets;
transmitting packets including the allocated sequence numbers to another communication device in an order in which the plurality of authentication generation processes are completed;
receiving a packet from the other communication device; and
executing a first authentication process in which the reception packet is authenticated based on a relationship between a sequence number of the reception packet and a sequence number of a preceding reception packet,
wherein the preceding reception packet is received before the reception packet, and has a sequence number that belongs to a sequence number group to which a sequence number of the reception packet belongs.

14. A communication system comprising:
a first communication device configured to execute, in parallel, a plurality of authentication generation processes, which are associated with different sequence number groups each including successive sequence numbers and which generate authentication information included in the packets based on sequence numbers allocated to the packets, and transmit packets including the allocated sequence numbers to a second communication device in an order in which the plurality of authentication generation processes are completed; and
a second communication device configured to receive a packet from the first communication device, and execute a first authentication process in which the reception packet is authenticated based on a relationship between a sequence number of the reception packet and a sequence number of a preceding reception packet,
wherein the preceding reception packet is received before the reception packet, and has a sequence number that belongs to a sequence number group to which a sequence number of the reception packet belongs.
